(19) United States
(12) Patent Application Publication
(10) Pub. No.: US 2022/0063379 A1
(43) Pub. Date: Mar. 3, 2022

(54) AIR VENTS PLATE FOR CAR WINDOWS

(71) Applicant: Jianbing Tang, Shenzhen (CN)

(72) Inventor: Jianbing Tang, Shenzhen (CN)

(21) Appl. No.: 17/235,881

(22) Filed: Apr. 20, 2021

(30) Foreign Application Priority Data
Sep. 2, 2020 (CN) 202021897457.4

(51) Int. Cl. B60H 1/26

(52) U.S. Cl. CPC B60H 1/267

(57) ABSTRACT

An air vents plate for car windows is disclosed, comprising air vents plate principal part installed inside the car window and adapted to the car window glass, the outer side of the air vents plate principal part is formed with a plurality of ventilating protrusions, the inner side of the air vents plate principal part is formed with a plurality of ventilating troughs at positions corresponding to the ventilating protrusions, and the bottom surfaces of the ventilating protrusions are formed with ventilating holes, the ventilating holes being connected to the ventilating troughs, so that air can go through the ventilating troughs and ventilating holes for air circulation between the inside and outside.

### BACKGROUND OF INVENTION

### 1. Field of the Invention

The present invention relates generally to the technical field of car accessories, and more particularly to an air vents plate for car windows.

### 2. Description of Related Art

As cars are used more and more people, various car accessories are developed. When the weather is rainy or snowy, to avoid water getting into the car, normally people in the car will not choose to open the windows. However, because the air humidity during rainy and snowy weather is relatively high, if there is no air flow inside the car, people sitting in the car will get uncomfortable. It is particularly the case for people with carsickness.

Among existing techniques, only automobile air-conditioners can realize the function of preventing rain water getting into the car while keeping air ventilation in the car. However, automobile air-conditioners consume a lot of energy. Moreover, the wind produced by air conditioners is not natural and can not provide satisfying comfort. In addition, in case the driver smokes during driving, the windows must be kept open to discharge the smoke. This is not possible during rainy weather. When the car is parked, if there is no ventilation inside the car, it may be dangerous when there is a baby or a pet inside the car.

In view of the above problems, the inventor has presented the following technical solution.

### SUMMARY OF THE INVENTION

The technical problem to be solved by the invention is to overcome the above problems and provide an air vents plate for car windows.

In order to solve the above technical problems, the present invention adopts the following technical solutions.

An air vents plate for car windows including an air vents plate principal part installed inside the car window and adapted to the car window glass, wherein an outer side of the air vents plate principal part is formed with a plurality of the ventilating protrusions, an inner side of the air vents plate principal part is formed with a plurality of ventilating troughs at positions corresponding to the ventilating protrusions, and bottom surfaces of the ventilating protrusions are formed with ventilating holes, the ventilating holes being connected to the ventilating troughs.

More particularly, wherein an upper end and two lateral sides of the air vents plate principal part are respectively formed with upper rim, left rim and right rim (103), the upper rim; the left rim and right rim are respectively adapted to an upper slot, a left slot and right slot inside the car window for insertion of car window glass; a lower end of the air vents plate principal part is formed with a clamping slot for insertion of car window glass.

More particularly, wherein the lower end of the air vents plate principal part is formed with a first clamping plate and a second clamping plate, symmetric to each other, and the clamping slot is formed between the first clamping plate and second clamping plate.

More particularly, wherein the ventilating protrusions is rectangular or trapezoid, distributed on the air vents plate principal part at a tilted angle, the included angle relative to a bottom surface of the air vents plate principal part being 60-80°.

More particularly, wherein the optimal angle between the ventilating protrusions and a horizontal plane of the bottom surface of the air vents plate principal part is 70°.

More particularly, wherein the upper and inner wall of the ventilating trough is configured as a slope.

More particularly, wherein the air vents plate principal part is integrally formed with PC hard plastic.

Based on the above design, to use the invention, lower the window glass and fit the air vents is plate principal part inside the window by insertion, and then lift the glass to fit into the bottom surface of the air vents plate principal part, so that the air vents plate principal part is fixed inside the car window. As the outer side of the air vents plate principal part is formed with a plurality of ventilating protrusions, the inner side of the air vents plate principal part is formed with a plurality of ventilating troughs at positions corresponding to the ventilating protrusions, and the bottom surfaces of the ventilating protrusions are formed with ventilating holes that are connected to the ventilating troughs, the ventilating troughs and ventilating holes can allow air circulation between the inside and outside. During driving, the driver will not feel high-pressure humming noise. During the summer season, after parking for some tune, it becomes hot inside the car, the heat can be released from the ventilating troughs and ventilating holes to lower the temperature inside the car. Because the ventilating holes are configured on the bottom surfaces of the ventilating protrusions, rain water cannot enter the window, Therefore, the present invention provides anti-theft, anti-heat and anti-rain effects. Even if the driver smokes during driving, the smoke can be quickly discharged through the ventilating troughs and ventilating holes. In the case of new-energy electric cars, when the battery is low and the air conditioner cannot be used, ventilation is still possible using ventilating troughs and ventilating holes of the air vents plate principal part, and people inside the car will not feel stuffy. When the car is parked, even if there is a baby or pet inside the car, there is still good ventilation through the ventilating troughs and ventilating holes of the air vents plate principal part, causing no danger. Hence, the present invention is very competitive in the market.

### BRIEF DESCRIPTION OF THE DRAWINGS

FIG. 1 is a perspective view of the invention;

FIG. 2 is a main view of the invention;

FIG. 3 is a sectional view of FIG. 2 along I-I direction.

### SUMMARY OF THE INVENTION

Further descriptions are provided below with reference to the accompanying figures.

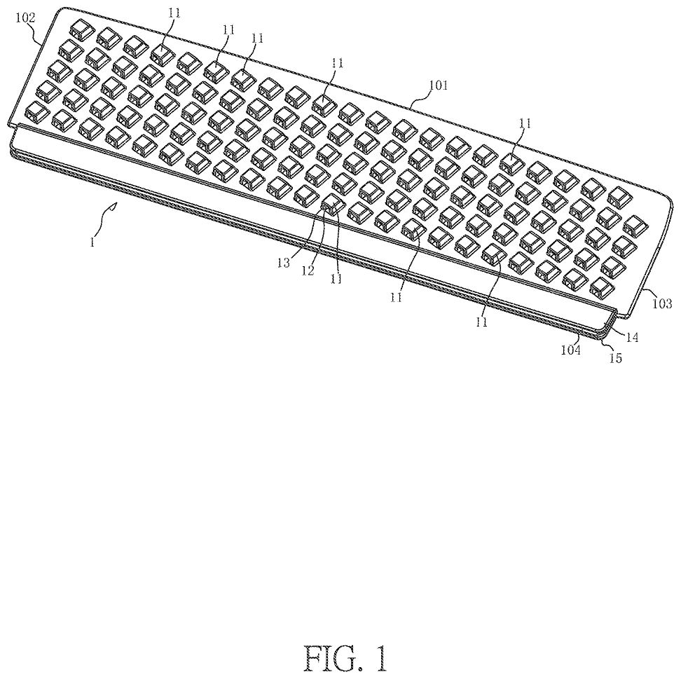

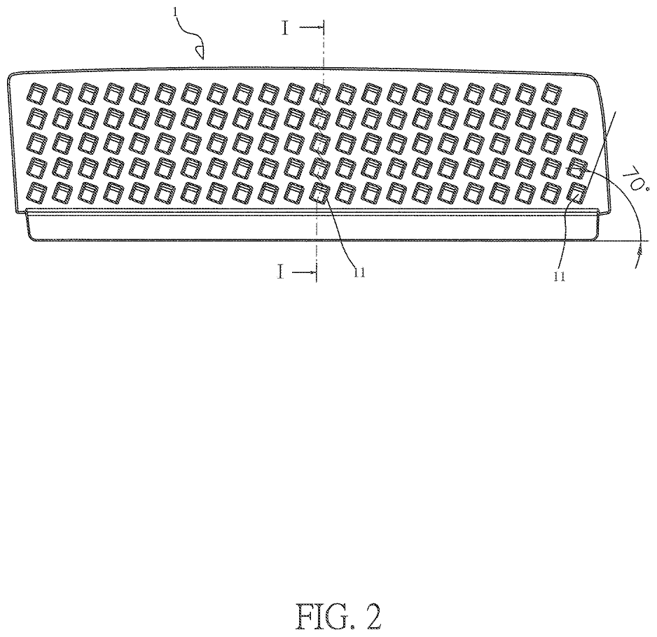

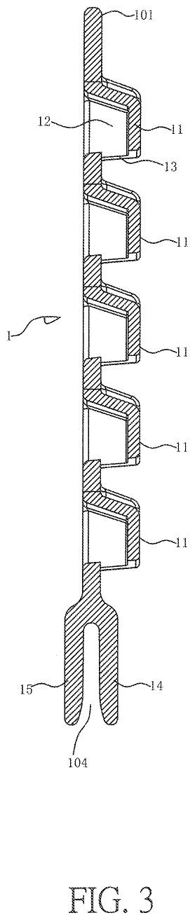

Referring to FIGS. 1-3, an air vents plate for car windows comprises an air vents plate principal part 1, installed inside the car window and adapted to the car window glass, the outer side of the air vents plate principal part 1 is formed with a plurality of ventilating protrusions 11, the inner side of the air vents plate principal part 1 is formed with a plurality of ventilating troughs 12 at positions corresponding to the ventilating protrusions 11, and the bottom surfaces of the ventilating protrusions 11 are formed with ventilating holes 13, the ventilating holes 13 being, connected to the ventilating troughs 12.

The upper end and two lateral sides of the air vents plate principal part 1 are respectively formed with upper rim 101, left rim 102 and right rim 103, the upper rim 101, left rim 102 and right rim 103 are respectively adapted to the upper slot, left slot and right slot inside the car window for insertion of window glass; the lower end of the air vents plate principal part 1 is formed with a clamping slot 104 for insertion of car window glass. The lower end of the air vents plate principal part 1 is formed with first clamping plate 14 and second clamping plate 15 that are symmetric to each other, and the clamping slot 104 is formed between the first clamping plate 14 and the second clamping plate 15. The ventilating protrusions 11 is rectangular or trapezoid, distributed on the air vents plate principal part 1 at a tilted angle, being 60-80° relative to a bottom surface of the air vents plate principal part 1. The optimal angle between the ventilating protrusions 11 and a horizontal plane of the bottom surface of the air vents plate principal part 1 is 70′. Thus, during driving, they can provide ventilation while avoiding noises. With ideal ventilation effect, they can also prevent rain water from entering the window. When the car is parked, they can radiate the heat. Even if sleeping inside the car, people will not feel stuffy.

The upper and inner wall of the ventilating trough 12 is configured as a slope to allow air flow, so as to provide better ventilation. Furthermore, the air vents plate principal part 1 is integrally formed with PC hard plastic.

Based on the above design, to use the invention, lower the window glass and fit the air vents plate principal part 1 inside the window by insertion, and then lift the glass to fit into the bottom surface of the air vents plate principal part 1, so that the air vents plate principal part 1 is fixed inside the car window. As the outer side of the air vents plate principal part 1 is formed with a plurality of ventilating protrusions 11, the inner side of the air vents plate principal part 1 is formed with a plurality of ventilating troughs 12 at positions corresponding to the ventilating protrusions 11, and the bottom surfaces of the ventilating protrusions 11 are formed with ventilating holes 13 that are connected to the ventilating troughs 12, the ventilating troughs 12 and ventilating holes 13 can allow air circulation between the inside and outside. During driving, the driver will not feel high-pressure humming noise. During the summer season, after parking for some time, it becomes hot inside the car, the heat can be released from the ventilating troughs 12 and ventilating holes 13 to lower the temperature inside the car. Because the ventilating holes 13 are configured on the bottom surfaces of the ventilating protrusions 11, rain water can not enter the window. Therefore, the present invention provides anti-theft, anti-heat and anti-rain effects. Even if the driver smokes during driving, the smoke can be quickly discharged through the ventilating troughs 12 and ventilating holes 13. In the case of new-energy electric cars, when the battery is low and the air conditioner can not be used, ventilation is still possible using ventilating troughs 12 and ventilating holes 13 of the air vents plate principal part 1, and people inside the car will not feel stuffy. When the car is parked, even if there is a baby or pet inside the car, there is still good ventilation through the ventilating troughs 12 and ventilating holes 13 of the air vents plate principal part 1, causing no danger. Hence, the present invention is very competitive in the market.

I claim:

1. An air vents plate for car windows including
an air vents plate principal part (1) installed inside the car window and adapted to the car window glass, wherein an outer side of the air vents plate principal part (1) is formed with a plurality of the ventilating protrusions (11), an inner side of the air vents plate principal part (1) is formed with a plurality of ventilating troughs (12) at positions corresponding to the ventilating protrusions (11), and bottom surfaces of the ventilating protrusions (11) are formed with ventilating holes (13), the ventilating holes (13) being connected to the ventilating troughs (12).

2. The air vents plate for car windows defined in claim 1, wherein an upper end and two lateral sides of the air vents plate principal part (1) are respectively formed with upper rim (101), left rim (102) and right rim (103), the upper rim (101); the left rim (102) and right rim (103) are respectively adapted to an upper slot, a left slot and right slot inside the car window for insertion of car window glass; a lower end of the air vents plate principal part (1) is formed with a clamping slot (104) for insertion of car window glass.

3. The air vents plate for car windows defined in claim 2, wherein the lower end of the air vents plate principal part (1) is formed with a first clamping plate (14) and a second clamping plate (15), symmetric to each other, and the clamping slot (104) is formed between the first clamping plate (14) and second clamping plate (15).

4. The air vents plate for car windows defined in claim 1, wherein the ventilating protrusions (11) is rectangular or trapezoid, distributed on the air vents plate principal part (1) at a tilted angle, the included angle relative to a bottom surface of the air vents plate principal part (1) being 60-80°.

5. The air vents plate for car windows defined in claim 4, wherein the optimal angle between the ventilating protrusions (11) and a horizontal plane of the bottom surface of the air vents plate principal part (1) is 70°.

6. The air vents plate for car windows defined in claim 4, wherein the upper and inner wall of the ventilating trough (12) is configured as a slope.

7. The air vents plate for car windows defined in claim 4, wherein the air vents plate principal part (1) is integrally formed with PC hard plastic.
